(19) United States
(12) Patent Application Publication
(10) Pub. No.: US 2021/0256077 A1
(43) Pub. Date: Aug. 19, 2021

(54) METHODS, DEVICES AND COMPUTER-READABLE STORAGE MEDIA FOR PROCESSING A HOSTED APPLICATION

(71) Applicant: SHANGHAI ZHANGMEN SCIENCE AND TECHNOLOGY CO., LTD., SHANGHAI (CN)

(72) Inventors: Yong SU, Shanghai (CN); Fei WANG, Shanghai (CN)

(73) Assignee: SHANGHAI ZHANGMEN SCIENCE AND TECHNOLOGY CO., LTD., SHANGHAI (CN)

(21) Appl. No.: 17/226,086

(22) Filed: Apr. 9, 2021

Related U.S. Application Data
(63) Continuation of application No. PCT/CN2019/110535, filed on Oct. 11, 2019.

(30) Foreign Application Priority Data
Oct. 12, 2018 (CN) 201811189573.8

(51) Int. Cl. G06F 16/958; G06F 16/954; G06F 16/955

(52) U.S. Cl. CPC G06F 16/958; G06F 16/955; G06F 16/954

(57) ABSTRACT

A method, a device and a computer readable storage medium for processing a hosted application. The method obtains a user's user operation which is based on a first application, and in turn obtains application function identification information of a hosted application on a second application according to the user operation, and to invoke the second application to run the hosted application to implement application functions according to the application function identification information of the hosted application.

### CROSS REFERENCE TO THE RELATED APPLICATION

This application is the continuation application of International Application No. PCT/CN2019/110535, filed on Oct. 11, 2019, which is based upon and claims priority to Chinese Patent Application No. 201811189573.8, filed on Oct. 12, 2018, the entire contents of which are incorporated herein by reference.

### FIELD

The present disclosure relates to terminal application technologies, and more particularly relates to methods, devices and computer-readable storage media for processing a hosted application.

### BACKGROUND

With the development of communication technologies, a terminal is integrated with more and more functions, and more and more corresponding applications (APPs) are contained in a list of system functions of the terminal. Some applications (which may be referred to as host applications) can provide some specific services from other applications (which may be referred to as hosted applications), for example specific services provided by a variety of applets such as a Mobike applet, a credit card applet in WeChat APP etc. The hosted application may be utilized without being installed and may implement corresponding functions. The range of the specific services of the hosted applications provided by the host application is less than or equal to those provided by independent applications which can operate independently and correspond to the hosted applications.

However, since the hosted applications provided in the host application operate completely with dependence on the trigger by the host application, the hosted applications can only be triggered by the host application to operate in the host application, which reduces the reliability of the operation of the hosted applications.

### SUMMARY

Various aspects of the present disclosure provide methods, devices and computer-readable storage media for processing a hosted application to improve the reliability of the operation of the hosted application.

An aspect of the present disclosure provides a method for processing a hosted application. The method comprises:

obtaining a user's user operation which is based on a first application;

obtaining application function identification information of the hosted application on a second application according to the user operation; and

invoking the second application to run the hosted application to implement application functions of according to the application function identification information of the hosted application.

Another aspect of the present disclosure provides a device. The device comprises:

one or more processors; and

a storage means for storing one or more programs,

and the one or more programs, when executed by the one or more processors, cause the one or more processors to implement the method for processing a hosted application as provided in one of the above aspects.

Yet another aspect of the present disclosure provides a computer-readable storage medium storing computer programs thereon, and the programs, when executed by a processor, implement the method for processing a hosted application as provided in one of the above aspects.

It can be seen from the above embodiments of the present disclosure obtains a user's user operation which is based on a first application; and in turn obtains application function identification information of a hosted application on a second application according to the user operation, to invoke the second application to run the hosted application to implement application functions according to the application function identification information of the hosted application. Since the hosted application provided in the host application (i.e., the second application) is no longer triggered in dependence on the host application, the hosted application can be triggered to operate by any other third-party application (i.e., the first application) without requiring being triggered by some specific host application, which improves the reliability of the operation of the hosted application.

In addition, the embodiments of the present disclosure are able to break the dependence of the operation of the hosted application on the trigger from a single host application, and the hosted application is triggerable and can be easily triggered by other third-party applications, which extends the operation of the hosted application to a larger range.

### DESCRIPTIONS OF THE DRAWINGS

In order to explain the embodiments of the present disclosure more clearly, drawings required to be used in the descriptions of embodiments or in the prior art will be briefly introduced below. The drawings described below are some embodiments of the present disclosure.

FIG. 1 is a schematic flowchart of a method for processing a hosted application provided by an embodiment of the present disclosure;

FIG. 2 is a block diagram of an exemplary computer system/server 12 suitable for implementing embodiments of the present disclosure.

### DETAILED EMBODIMENTS

The embodiments of the present disclosure will be described clearly and fully with reference to the accompanying drawings in the embodiments of the present disclosure below. The described embodiments are a part of embodiments of the present disclosure, but not all the embodiments.

It should be noted that the terminal involved in the embodiments of the present disclosure may include but is not limit to: a mobile phone, a personal digital assistant (PDA), a hand-held wireless device, a tablet computer, a personal computer (PC), an MP3 player, an MP4 player, a wearable device such as smart glasses, a smart watch, a smart wristband, etc.

In addition, the term “and/or” herein only refers to an association relationship which describes associated objects, and represents that there may be three relationships. For example, A and/or B may represent three situations: A exists alone, A and B exist at the same time, or B exists alone. In addition, the character “I” in this document generally represents that the associated objects before and after the character are in an “or” relationship.

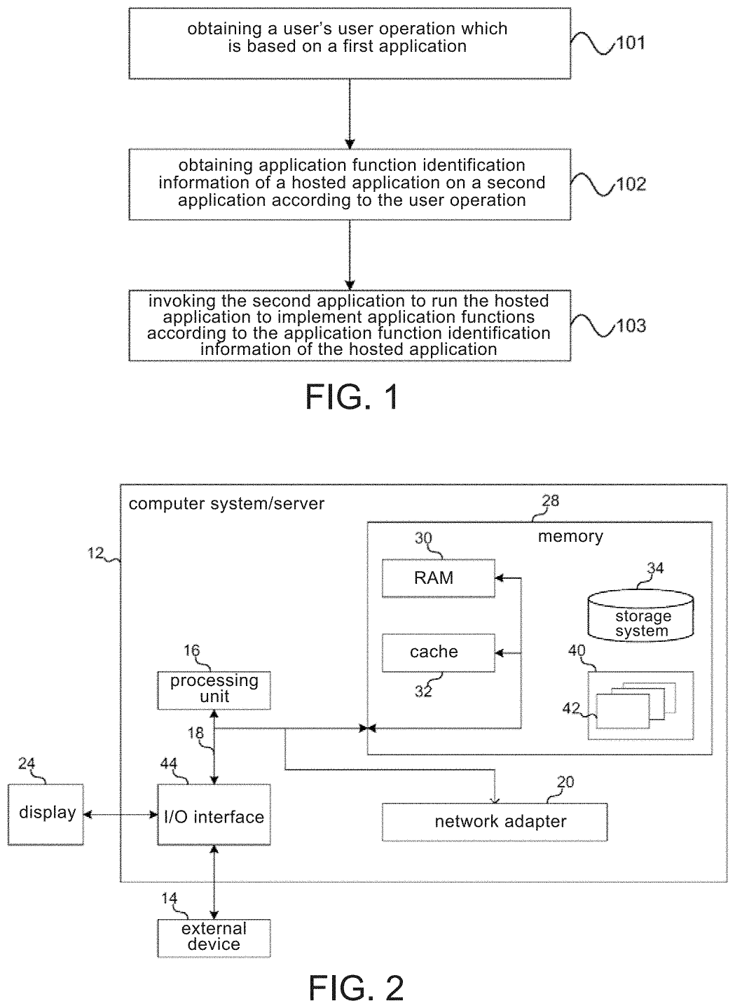

FIG. 1 is a schematic flowchart of a method for processing a hosted application provided by an embodiment of the present disclosure, as shown in FIG. 1.

At 101, a user's user operation which is based on a first application is obtained.

At this time, the operating system of a terminal is running the first application. The so-called running means that the operating system of the terminal is run by a window in the foreground.

At 102, application function identification information of a hosted application on a second application is obtained according to the user operation.

The so-called second application refers to a host application which provides the hosted application, such as WeChat application, QQ application, etc.

At 103, the second application is invoked to run the hosted application to implement application functions according to the application function identification information of the hosted application.

It should be noted that the executing entity for part or all of steps 101 to 103 may be the first application located on the terminal, a functional unit set in the first application located on the terminal such as a plug-in or a software development kit (SDK), a hosted application platform located in a network server, or a distributed system located on the network side, which is not specifically limited in the embodiment.

It should be noted that the first application may be a native application (nativeApp) installed on the terminal, or a webpage application (webApp) of a browser on the terminal, which is not limited in the embodiment. The second application may be a native application (nativeApp) installed on the terminal, or a webpage application (webApp) of a browser on the terminal, which is not limited in the embodiment. For example, the second application may be a social networking service (SNS) application, an instant messaging (IM) application, etc. installed on the terminal. The type of the second application is not limited in the present embodiment. The hosted application may be a local application (i.e., an applet) which is not required to be installed on the terminal and is triggered to operate by a user of the second application, and may be referred to as a hosted application.

As such, a user's user operation which is based on a first application is obtained; and in turn application function identification information of the hosted application on a second application is obtained according to the user operation, to invoke the second application to run the hosted application to implement application functions according to the application function identification information of the hosted application. Since the hosted application provided in the host application (i.e., the second application) is no longer triggered in dependence on the host application, the hosted application can be triggered to operate by any other third-party application (i.e., the first application) without requiring being triggered by some specific host application, which improves the reliability of the operation of the hosted application.

In one embodiment, the application function identification information of the hosted application may be in a form of a page jump protocol in IOS system or Android system, for example, in a form of a uniform resource locator (URL) scheme protocol such as wexin://appbrand/appid, and the weixin represents the scheme protocol of the host application which provides the hosted application. In one embodiment, the application function identification information of the hosted application may be in a form of a system interface in Android system, for example, in a form of an intent object interface and a bundle object interface, etc., which is not specifically limited in the embodiment.

In a specific implementation, the application function identification information of the hosted application may include but is not limited to application identification information of the hosted application, which is not specifically limited in the embodiment. At this time, the application function identification information of the hosted application may indicate to run the hosted application in the host application, to open the default page of the hosted application such as a home page of an applet.

The application identification information of the hosted application may include but is not limited to a brand of the hosted application (appbrand) and an identifier of the hosted application (appid), which is not specifically limited in the embodiment. The brand of the hosted application (appbrand) is used to indicate functions of the hosted application. The identifier of the hosted application (appid) is used to indicate the hosted application.

For example, the application identification information of the hosted application may be wexin://appbrand/appid, etc.

In another specific implementation, the application function identification information of the hosted application may include the application identification information of the hosted application and the page identification information (page) of the hosted application. At this time, the application function identification information of the hosted application may indicate to run the hosted application in the host application, to open a designated page of the hosted application, i.e., a page of an applet identified by the page identification information (page), etc.

The application identification information of the hosted application may include but is not limited to a brand of the hosted application (appbrand) and an identifier of the hosted application (appid), which is not specifically limited in the embodiment. The brand of the hosted application (appbrand) is used to indicate functions of the hosted application. The identifier of the hosted application (appid) is used to indicate the hosted application.

As an example, the application identification information of the hosted application may be wexin://appbrand/appid, etc.

As another example, the application function identification information of the hosted application may be wexin://appbrand/appid/page.

On the basis of the above two specific implementations, the application function identification information of the hosted application may further comprise parameter information required by the application function. At this time, the parameter information required by the application function may indicate some parameters required for the hosted application in the host application to operate. As an example, a starting point and an ending point are required for a map applet in the WeChat application to operate to plan a route. In one embodiment, as another example, a departure date and a return date are required for a flight ticket applet in the WeChat application to operate to plan a trip, and so on.

This embodiment, at 102, specifically an instruction for invoking the hosted application triggered by the user's user operation which is based on the first application may be obtained. In turn, the application function identification information of the hosted application may be obtained according to the instruction for invoking.

In specific, the instruction for invoking the hosted application triggered by the user's user operation which is based on an icon of the hosted application outputted by the first application may be obtained.

In this implementation, the instruction for invoking the hosted application triggered by the user's user operation which is based on the icon of the hosted application may be further obtained after the first application outputs the icon of the hosted application.

The user operation includes operation gestures. The operation gestures may include but are not limited to at least one of the following operation gestures:

an operation gesture of the user operating on the icon of the hosted application;

an operation gesture of the user hovering on the page where the icon of the hosted application is located;

an operation gesture of the user touching the page where the icon of the hosted application is located; and

the user carrying the terminal with a motion that produces a motion trend when the page where the icon of the hosted application is located is displayed.

The operation gesture of the user operating on the icon of the hosted application may refer to a user operation such as a click operation on the icon of the hosted application displayed on a display device of the terminal. This so-called click operation may be a trigger operation performed by the user with an external input device such as a mouse or a keyboard to control a cursor, or a touch operation performed by the user with a touch input device such as a finger or a stylus, which is not specifically limited in the embodiment.

The operation gesture of the user hovering on the page where the icon of the hosted application is located may refer to the user hovering and sliding with a track on the page displayed on the display device of the terminal where the icon of the hosted application is located within a collection range of an image sensor of the terminal. The image sensor may be a charge coupled device (CCD) sensor, or a complementary metal-oxide semiconductor (CMOS) sensor, which is not specifically limited in the embodiment. The track accompanied with the hovering and sliding may include but is not limited to a straight line or a curve of any shape composed of several hold points corresponding to several continuous sliding events, which is not specifically limited in the embodiment.

The operation gesture of the user touching the page where the icon of the hosted application is located may refer to the user touching and sliding with a track on the page displayed on the display device of the terminal where the icon of the hosted application is located. Generally, terminals may be divided into two types based on whether the display device is touch-sensitive, one is a touch-sensitive terminal, and the other is a non-touch-sensitive terminal. In one embodiment, an operation gesture of the user touching the page displayed on the touch screen of the touch-sensitive terminal where the icon of the hosted application is located may be detected. The track accompanied with the touching and sliding may include but is not limited to a straight line or a curve of any shape composed of several touch points corresponding to several continuous touch events, which is not specifically limited in the embodiment. For example, the operation gesture may be an operation gesture of the user long pressing in the middle area of the page where the icon of the hosted application is located.

The motion trend of the terminal driven by the motion of the user based on the page where the icon of the hosted application is located may refer to a motion track of the terminal driven by the motion of the user (such as shaking, flipping, etc.) while the user is holding the terminal when the page where the icon of the hosted application is displayed on the display device of the terminal.

In one embodiment, a sensor device may be utilized to detect the operation gesture of the user on the page where the icon of the hosted application is located. In one embodiment, the sensor device may include but is not limited to at least one of a gravity sensor, an acceleration sensor, a pressure sensor, an infrared sensor, a distance sensor and an image sensor, which is not specifically limited in the embodiment.

The distance sensor may be an ultrasonic distance sensor, an infrared distance sensor, a laser distance sensor or a microwave distance sensor, which is not specifically limited in the embodiment. These distance sensors are all existing mature techniques, and the detailed descriptions may be made reference to related contents in the prior art, which will not be repeated here.

The image sensor may be a charge coupled device (CCD) sensor, or a complementary metal-oxide semiconductor (CMOS) sensor, which is not specifically limited in the embodiment.

In one embodiment, detecting the operation gesture of the user on the page where the icon of the hosted application is located may refer to detecting the starting point, the ending point, and the track formed from the starting point to the ending point for the operation gesture of the user on the page where the icon of the hosted application is located, or may also refer to detecting radian data corresponding to the track.

In order to realize the above functions, designated operations may further be preset. Only when the obtained user operation matches the preset designated operation, the instruction for invoking the hosted application may be triggered according to the obtained user operation which is based on the icon of the hosted application.

In an example where the obtained user operation comprises the operation gesture, after the operation gesture of the user which is based on the icon of the hosted application is obtained, the operation gesture may be compared with a preset designated gesture. The instruction for invoking the hosted application may be triggered only when the obtained operation gesture matches the preset designated gesture.

In specific, data on the designated gestures may be stored in a storage device of the terminal.

As an example, the storage device of the terminal may be a slow storage device. In specific, the storage device may be a hard disk of a computer system, or a non-operational memory (i.e., a physical memory) of a mobile phone, such as a read-only memory (ROM) and a memory card, etc., which is not specifically limited in the embodiment.

In one embodiment, as another example, the storage device of the terminal may also be a fast storage device. The storage device may specifically be a memory of a computer system, or an operational memory (i.e., a system memory) of a mobile phone, such as a random access memory (RAM), etc., which is not specifically limited in the embodiment.

This embodiment, an application platform of the second application and an application platform of the hosted application are integrated, and may be referred to as a system application platform. At this time, the hosted application provided in the second application (i.e., the host application) is completely dependent on the host application, and the hosted application can only operate in the specific host application.

In this implementation, at 103, specifically the second application may utilize the system application platform to parse and process designated application components of the hosted application to obtain executable files of the hosted application, or to obtain executable files of the hosted application directly, which is not specifically limited in the embodiment. The designated application components of the hosted application may be all or parts of the application components of the hosted application, which is not specifically limited in the embodiment. After the executable files of the hosted application are obtained, the second application then may run the executable files, to run the hosted application to implement application functions.

This embodiment, at 103, specifically the second application may operate according to the application function identification information of the hosted application. In turn, the hosted application may be invoked to run the application functions of the hosted application with an invoking interface between the second application and the hosted application.

In one embodiment, a designated page of the second application may be outputted according to the application function identification information of the hosted application, such as the last page operated by the second application before, or the home page of the second application, etc.

In specific, the output duration and the output style of the designated page may be set to implement rapid rendering of the designated page.

As an example, the output duration of the designated page may be set as a preset time threshold such as 1 second. At this time, the second application flashes in and out of the screen.

In one embodiment, as another example, for Android system, the home page of the application may be set as a transparent page since an application in Android system has multiple entrances. At this time, the user is unaware of the output of the designated page of the second application.

These embodiments obtain a user's user operation which is based on a first application; and in turn obtain application function identification information of the hosted application on a second application according to the user operation, to invoke the second application to run the hosted application to implement application functions according to the application function identification information of the hosted application. Since the hosted application provided in the host application (i.e., the second application) is no longer triggered in dependence on the host application, the hosted application can be triggered to operate by any other third-party application (i.e., the first application) without requiring being triggered by some specific host application, which improves the reliability of the operation of the hosted application.

In addition, the embodiments of the present disclosure are able to break the dependence of the operation of the hosted application on the trigger from a single host application, and the hosted application is triggerable and can be easily triggered by other third-party applications, which extends the operations of the hosted applications to a larger extent.

In addition, the embodiments provided by the present disclosure is able to enhance user experience effectively.

In the above embodiments, the description of each embodiment has its own emphasis. For a part that is not described in detail in an embodiment, reference may be made to related descriptions in other embodiments.

FIG. 2 shows a block diagram of an exemplary computer system/server 12 suitable for implementing the embodiments of the present disclosure. The computer system/server 12 shown in FIG. 2 is merely an example, and should not impose any limitation on the functions and scope of use of the embodiments of the present application.

As shown in FIG. 2, the computer system/server 12 is embodied as a general-purpose computing device. Components of the computer system/server 12 may include but are not limited to one or more processors or processing units 16, a storage means or a system memory 28, a bus 18 connecting different system components (including the system memory 28 and the processing unit 16).

The bus 18 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 12 typically includes a variety of computer system readable media. These media can be any available media that can be accessed by the computer system/server 12, including volatile and non-volatile media, removable and non-removable media.

The system memory 28 may include computer system readable media in the form of a volatile memory, such as a random access memory (RAM) 30 and/or a cache memory 32. The computer system/server 12 may further include other removable/non-removable, volatile/nonvolatile computer system storage media. By way of example only, the storage system 34 may be used to read and write a non-removable, non-volatile magnetic medium (not shown in FIG. 2 and is commonly referred to as a “hard drive”). Although not shown in FIG. 2, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 18 through one or more data media interfaces. The system memory 28 may include at least one program product having a set of (e.g., at least one) program modules configured to perform the functions of the embodiments of the present disclosure.

A program/utility tool 40 having a set of (at least one) program modules 42 may be stored in, for example, the system memory 28. Such program modules 42 include, but are not limited to, an operating system, one or more application programs, other programs modules and program data, each or some combination of these examples may include implementations of the network environment. The program modules 42 generally perform functions and/or methods in the embodiments described in the present disclosure.

The computer system/server 12 can also communicate with one or more external devices 14 (e.g., a keyboard, a pointing device, a display 24, etc.), and can also communicate with one or more devices that enable users to interact with the computer system/server 12, and/or with any device (such as a network card, a modem, etc.) that enables the computer system/server 12 to communicate with one or more other computing devices. Such communication can be performed through an input/output (I/O) interface 44. Moreover, the computer system/server 12 can also communicate with one or more networks (such as a local area network (LAN), a wide area network (WAN), and/or a public network, such as the Internet) through a network adapter 20. As shown in the figures, the network adapter 20 communicates with other modules of the computer system/server 12 through the bus 18. It should be understood that although not shown in the figure, other hardware and/or software modules may be used in conjunction with the computer system/server 12, including but not limited to: microcode, device drivers, redundant processing units, external disk drive arrays, RAID systems, tape drives and data backup storage systems.

The processing unit 16 executes programs stored in the system memory 28 to execute various functional applications and data processing, for example, to implement the method for processing a hosted application provided in any one of the embodiments corresponding to FIG. 1.

Another embodiment of the present disclosure also provides a computer-readable storage medium storing computer programs thereon. The programs, when executed by a processor, implement the method for processing a hosted application provided in any one of the embodiments corresponding to FIG. 1.

In specific, any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus or device.

Program code embodied on computer-readable media may be transmitted using any appropriate media, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

In the several embodiments provided by the present disclosure, it should be understood that the disclosed system, apparatus and method etc., may be implemented in other ways. By way of example, the apparatus embodiments described above are merely schematic. For example, the division of the units is only a logical function division, and there may be another division manner in actual implementation. As an example, multiple units or page components may be combined or integrated into another system. In one embodiment, some features may be ignored or not implemented. As another example, mutual coupling or direct coupling or communication connection demonstrated or discussed herein may be indirect coupling or communication connection through some interfaces, apparatuses or units, and may be electrical, mechanical or in other forms.

The units described as separate components may or may not be physically separated, and the components displayed as units may or may not be physical units. They may be located in one place, or may be distributed on multiple network units.

In addition, each functional unit in the embodiments of the present disclosure may be integrated into one processing unit, or each unit may exist separately physically, or two or more units may be integrated into one unit. The above integrated unit may be implemented in the form of hardware, or in the form of hardware plus software functional units.

The above integrated unit implemented in the form of a software functional unit may be stored in a computer-readable storage medium. The above software functional unit is stored in a storage medium and includes several instructions for causing a computer device (which may be a personal computer, a server, or a network device) or a processor to execute some steps of the methods described in the embodiments of the present disclosure. The foregoing storage medium includes various media that can store program codes, such as a U disk, a mobile hard disk, a read-only memory (ROM), a random access memory (RAM), a magnetic disk, or an optical disc.

What is claimed is:

1. A method for processing a hosted application, comprising:
obtaining a user's user operation which is based on a first application;
obtaining application function identification information of the hosted application on a second application according to the user operation; and
invoking the second application to run the hosted application to implement application functions according to the application function identification information of the hosted application.

2. The method according to claim 1, wherein the application function identification information of the hosted application is in form of a page jump protocol or a system interface.

3. The method according to claim 1, wherein the application function identification information of the hosted application comprises: application identification information of the hosted application; or
application identification information of the hosted application and page identification information of the hosted application.

4. The method according to claim 3, wherein the application identification information of the hosted application comprises a brand of the hosted application and an identifier of the hosted application.

5. The method according to claim 3, wherein the application function identification information of the hosted application further comprises parameter information required by the application function.

6. The method according to claim 1, wherein invoking the second application to run the hosted application to implement application functions according to the application function identification information of the hosted application comprises:
running the second application according to the application function identification information of the hosted application;
invoking the hosted application to run application functions of the hosted application with an invoking interface between the second application and the hosted application.

7. The method according to claim 6, wherein running the second application according to the application function identification information of the hosted application comprises:
outputting a designated page of the second application according to the application function identification information of the hosted application.

8. The method according to claim 7, wherein the designated page of the second application is configured as a transparent page.

9. A device, comprising:
one or more processors; and
a storage means for storing one or more programs,
wherein the one or more programs, when executed by the one or more processors, cause the one or more processors, cause the one or more processors to:
obtain a user's user operation which is based on a first application;
obtain application function identification information of a hosted application on a second application according to the user operation; and
invoke the second application to run the hosted application to implement application functions according to the application function identification information of the hosted application.

10. A computer-readable storage medium storing computer programs thereon, the computer programs, when executed by a processor, cause the one or more processors to:
obtain a user's user operation which is based on a first application;
obtain application function identification information of a hosted application on a second application according to the user operation; and
invoke the second application to run the hosted application to implement application functions according to the application function identification information of the hosted application.
